(19) United States
(12) Patent Application Publication
(10) Pub. No.: US 2026/0328320 A1
(43) Pub. Date: Oct. 22, 2026

(54) FLUID INJECTION SYSTEM

(71) Applicant: PETRÓLEO BRASILEIRO S.A. - PETROBRAS, Rio de Janeiro (BR)

(72) Inventors: ROMARIO DE CARVALHO NUNES, Macaé (BR); JOAO PAULO URBANO, Macaé (BR)

(21) Appl. No.: 19/644,371

(22) Filed: Apr. 10, 2026

(30) Foreign Application Priority Data
Apr. 17, 2025 (BR) 1020250076829

(51) Int. Cl. F16L 27/08

(52) U.S. Cl. CPC F16L 27/0804

(57) ABSTRACT

The present invention is applied in the field of subsea equipment technologies and, more particularly, relates to a fluid injection system comprising: an adapter connected by means of a nozzle to a subsea equipment interface for injecting fluids therein, wherein the adapter is in fluid communication with the subsea equipment interface; a receptacle connected to an upper end of the adapter, wherein the receptacle is in fluid communication with the adapter; a hot stab connected to an upper end of the receptacle, wherein the hot stab is in fluid communication with the receptacle; and a swivel connected to an upper end of the hot stab, wherein the swivel is in fluid communication with the hot stab; wherein the nozzle of the adapter has protrusions around the same, to be locked onto the subsea equipment interface, after turning an outer part of the adapter.

### CROSS REFERENCE TO RELATED APPLICATIONS

The present application claims priority to BR Pat. App. No. 1020250076829 filed on Apr. 17, 2025, which is hereby incorporated by reference in its entirety.

### Field of the Invention

The present invention is applied in the field of subsea equipment technologies and, more particularly, relates to a fluid injection subsea system operated by a remotely operated vehicle (ROV) for actuation on an interface commonly used for human intervention for fluid transfer.

### Backgrounds of the Invention

The fluid injection through a pressurization connector (better known as a “hot stab”) depends on several factors to achieve adequate and appropriate productivity for the desired scenario. Thus, the hot stab is a piece of equipment that acts as a pressurization system associated with an injection tip, and can be a tool used for injecting fluids with controlled pressure and flow rate.

Some subsea equipment requires pressurized injections of various liquids to perform multiple functions, such as: testing to ensure the tightness of metallic and elastomeric sealings, as well as moving cylinders and operating hydraulic circuits; injecting control fluids and energizing subsea tools and hydraulic circuits.

Currently, the fluid injection into certain subsea equipment and locations (such as valves, for example) is done by using a tool handled and operated by a diver, which limits the operation on-site and can generate considerable risk for the diver and the operation as a whole.

Even some devices designed for ROV operation have limitations in their applicability in more complex scenarios, in which it is necessary, for example, to adjust the position of the jumper to avoid damaging the jumper structure or even the hot stab connected to the same. In addition, in many cases, the hot stab needs a base to firmly connect to the interface, so this base should preferably be easy to connect and remove from the equipment to be actuated.

Therefore, there is currently a need in the state of the art for the development of a fluid injection system that can be handled by ROV and is suitable for locations in which it was previously only possible through a tool handled by a diver. Thus, the technical problem that led to the development of the present invention concerns the lack of a solution for fluid injection through an ROV in a certain location that would only be actuated via a diver tool handled by the diver.

### State of the Art

The State of the Art shows some documents that disclose matters within the technological field of the present invention.

Document US 8,096,731 B2 discloses a connection assembly for connecting subsea lines and devices. The assembly includes a fitting receptacle assembly and a fitting assembly. The fitting receptacle assembly includes a receptacle body and an outlet assembly, which in turn includes an adapter nozzle configured for attachment to the first subsea line. A swivel flange secures the adapter nozzle to the first side of the receptacle body. The use of the adapter nozzle and swivel flange eliminates a difficult weld between the adapter nozzle and the receptacle body. The connection assembly further includes a fitting assembly that has a base, a line end connected to the base, and a fitting body connected to the base. The fitting body is configured for insertion into the fitting receptacle. The line end is configured for connection to the second subsea line.

However, the swivel flange of the assembly in US patent 8,096,731 B2 is a mechanism arranged laterally in its receptacle to facilitate its attachment to a subsea piece of equipment. On the other hand, in the present invention, a swivel (rotating connector) is attached to the top of the hot stab, having a portion for fitting a jumper or hydraulic hose, so that the jumper can be placed in various positions around the hot stab, facilitating both the positioning of the system and the jumper. In addition, US patent 8,096,731 B2 does not disclose or suggest the use of an adapter with spare parts that transforms the operating interface of diver tools into that of an ROV.

Moreover, document US 10,107,059 B2 discloses a stab connector for providing a fluid flow path between a first fluid reservoir and a second fluid reservoir, comprising a stab body couplable to a receptacle in fluid communication with the second fluid reservoir and movable within the receptacle between a sealing position, in which the fluid flow in the fluid flow path between the first fluid reservoir and the second fluid reservoir is prevented, and a flow position, in which the fluid flow in the fluid flow path between the first fluid reservoir and the second fluid reservoir is permitted.

However, the connector proposed by document US 10,107,059 B2 describes a receptacle that has an outlet positioned laterally in its body. In addition, the aforementioned document does not disclose or suggest the use of an adapter connected below the receptacle to adapt a connection interface, or a swivel on the upper portion of a hot stab to allow the rotation of a hydraulic hose or jumper.

Therefore, none of the documents of the state of the art are able to suggest or disclose a fluid injection system that has an adapter capable of transforming a diver tool operating interface into that of an ROV, or even a swivel assembly fitted to the upper portion of the hot stab to allow the jumper to be positioned at various desired angles.

### Brief Description of the Invention

The solution proposed by the present invention consists of the development of a fluid injection system handled by an ROV to be applied in locations where previously it was only possible to operate using a diver tool. The system of the present invention has an adapter that transforms the diver tool operating interface into that of an ROV, promoting a safer and more efficient approach in the underwater operations.

In addition, the system also features a swivel, which allows an injection hose (hydraulic jumper, for example) to be positioned at different desired angles without twisting the hose. This flexibility is crucial for optimizing the operational efficiency, as it allows access to hard-to-reach areas and improves the precision in task execution. Additionally, the ability to adjust the hose position contributes to a safer and more controlled handling, reducing the risk of accidents and ensuring a smoother operation. In complex environments, where the visibility and the mobility may be limited, this functionality becomes even more important, allowing the ROV to perform interventions effectively and more safely. The solution presented by the present invention is also very versatile, as it consists of a system of components that can be used with other tools developed for the same.

Accordingly, the objectives and advantages of the present invention are achieved by providing a fluid injection system comprising: an adapter connected by means of a nozzle to a subsea equipment interface for injecting fluids therein, wherein the adapter is in fluid communication with the subsea equipment interface; a receptacle connected to an upper end of the adapter, wherein the receptacle is in fluid communication with the adapter; a hot stab connected to an upper end of the receptacle, wherein the hot stab is in fluid communication with the receptacle; and a swivel connected to an upper end of the hot stab, wherein the swivel is in fluid communication with the hot stab; wherein the adapter nozzle has protrusions around the same to be locked onto the subsea equipment interface after rotating an outer part of the adapter.

### BRIEF DESCRIPTION OF THE FIGURES

The preferred embodiments of this invention will be better understood when read in conjunction with the accompanying drawings. It should be understood, however, that the invention in question is not limited only to the precise arrangements and instruments shown.

Thus, the present invention will now be described with reference to its typical embodiments and with reference to the attached drawings, in which:

FIG. 1A shows a schematic front view of a fluid injection system containing its main components, according to an embodiment of the present invention.

FIG. 1B shows a cross-sectional view of a section Q-Q of the fluid injection system of FIG. 1A, according to an embodiment of the present invention.

FIG. 2A shows a perspective view of an upper handle of the system, according to an embodiment of the present invention.

FIG. 2B shows a side view of the upper handle of the system, according to an embodiment of the present invention.

FIG. 3A shows a first perspective view of a receptacle of the system, according to an embodiment of the present invention.

FIG. 3B shows a second perspective view of a receptacle of the system, according to an embodiment of the present invention.

FIG. 3C shows a front view of a receptacle of the system, according to an embodiment of the present invention.

FIG. 3D shows a side view of a receptacle of the system, according to an embodiment of the present invention.

FIG. 3E shows a top view of a receptacle of the system, according to an embodiment of the present invention.

FIG. 3F shows a cross-sectional view of a CP-CP section of the receptacle of FIG. 3E, according to an embodiment of the present invention.

FIG. 4A shows a cross-sectional view of part of the fluid injection system, highlighting the fluid flowing through the swivel, hot stab, and receptacle, according to an embodiment of the present invention.

FIG. 4B shows a cross-sectional and perspective view of part of the fluid injection system, highlighting the internal part of the swivel, hot stab, and receptacle, according to an embodiment of the present invention.

FIG. 5A shows a first perspective view of a hot stab of the system, according to an embodiment of the present invention.

FIG. 5B shows a second perspective view of a hot stab of the system, according to an embodiment of the present invention.

FIG. 5C shows a front view of a hot stab of the system, according to an embodiment of the present invention.

FIG. 6A shows a perspective view of a hot stab connected to a receptacle, according to an embodiment of the present invention.

FIG. 6B shows a perspective view of a hot stab, according to an embodiment of the present invention.

FIG. 7 shows a perspective view of an upper handle of the system, according to an embodiment of the present invention.

FIG. 8A shows a front view of a lower assembly of the system, consisting of a receptacle, hot stab, swivel, and upper handle, according to an embodiment of the present invention.

FIG. 8B shows a perspective view of a lower assembly of the system, consisting of a receptacle, hot stab, swivel, and upper handle, according to an embodiment of the present invention.

FIG. 9A shows a cutaway view highlighting the inner part of the swivel, according to an embodiment of the present invention.

FIG. 9B shows a cutaway view highlighting the inner part of the swivel and its connection to the hot stab, according to an embodiment of the present invention.

FIG. 10A shows a perspective view of a portion of the moving part of the swivel, according to an embodiment of the present invention.

FIG. 10B shows a front view of a portion of the moving part of the swivel, according to an embodiment of the present invention.

FIG. 10C shows a cutaway view of a BV-BV section of a portion of the moving part of the swivel of FIG. 10B, according to an embodiment of the present invention.

FIG. 11 shows a perspective view of a fixed part of the swivel, according to an embodiment of the present invention.

FIG. 12A shows a perspective view of a blind hot stab of the system, according to an embodiment of the present invention.

FIG. 12B shows a front view of the blind hot stab of the system with a monkey fist connected to the same, according to an embodiment of the present invention.

FIG. 12C shows a cross-sectional view of a C-C section of the blind hot stab of FIG. 12B connected to the receptacle, according to an embodiment of the present invention.

FIG. 13A shows a side view of a lower assembly of the system being aligned by an ROV to a subsea equipment interface, according to an embodiment of the present invention.

FIG. 13B shows a perspective view of a lower assembly of the system being aligned by an ROV to a subsea equipment interface, according to an embodiment of the present invention.

FIG. 14A shows a side view of a lower assembly of the system being connected by an ROV to a subsea equipment interface, according to an embodiment of the present invention.

FIG. 14B shows a perspective view of a lower assembly of the system being connected by an ROV to a subsea equipment interface, according to an embodiment of the present invention.

FIG. 15A shows a side view of an upper assembly, with a hose or jumper connected to the same, being aligned by an ROV to the lower assembly already connected to the subsea equipment interface, according to an embodiment of the present invention.

FIG. 15B shows a perspective view of an upper assembly, with a hose or jumper connected to the same, being aligned by an ROV to the lower assembly already connected to the subsea equipment interface, according to an embodiment of the present invention.

FIG. 16A shows a side view of an upper assembly, with a hose or jumper connected to the same, being connected by an ROV to the lower assembly already connected to the subsea equipment interface, according to an embodiment of the present invention.

FIG. 16B shows a perspective view of an upper assembly, with a hose or jumper connected to the same, being connected by an ROV to the lower assembly already connected to the subsea equipment interface, according to an embodiment of the present invention.

### DETAILED DESCRIPTION OF THE INVENTION

Reference is made in detail hereto to preferred embodiments of the present invention, illustrated in the accompanying drawings. Wherever possible, the same or similar reference numbers will be used throughout the drawings to refer to identical or similar features. It should be noted that the drawings are in simplified form and are not represented to precise scale, so small variations are expected.

The present invention relates to a fluid injection system via ROV that aims to contribute to the replacement of the traditional work performed by divers with automated operations using ROVs, which substantially reduces the risks to the safety of the professionals, minimizing exposure to hazardous environments.

The present invention addresses to and reduces the difficulties mentioned above, having been specifically designed for ROVs. In addition, by means of the use of the system of the present invention, it is possible to adapt operations that previously required the use of manual tools by divers, now being able to be performed by ROVs. This transformation is of paramount importance, as it significantly contributes to the safety of life, minimizing the exposure of divers to potentially hazardous environments. This is possible thanks to an adapter that transforms the operating interface of diver tools to that of ROV, promoting a safer and more efficient approach in underwater operations.

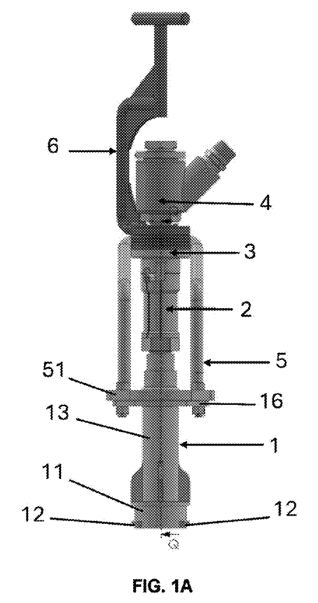

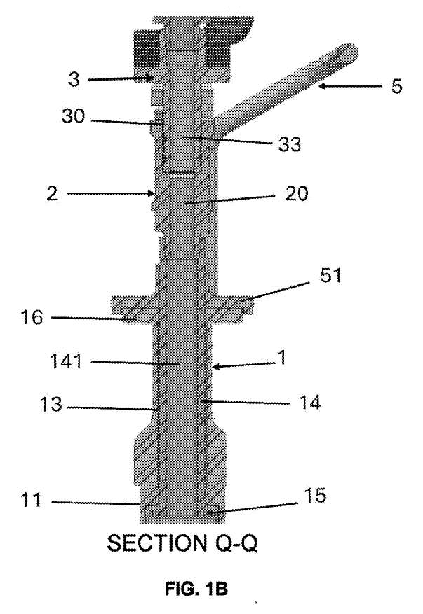

Reference is thus made to FIGS. 1A and 1B, which show a fluid injection system containing its main components, according to an embodiment of the present invention. The fluid injection system comprises an adapter (1) connected by means of a nozzle (11) to a subsea equipment interface for injecting fluids therein. Thus, the adapter (1) is positioned on the subsea equipment interface commonly used for human intervention (by a diver) for fluid transfer. As shown in FIGS. 1A and 1B, the adapter (1) has an outer part (13) and an inner part (14), with the nozzle (11) located at the lower end of the outer part (13) and configured to be connected to the subsea equipment interface (such as a valve interface, for example). It should be highlighted that the outer part (13) is free to rotate and the inner part (14) is attached (i.e., does not rotate) to the subsea equipment interface by means of a polymer sealing ring (15) (O-ring) disposed between the inner part (14) and the subsea equipment interface. The function of the sealing ring (15) is to prevent the fluid being transported from the adapter (1) towards the subsea equipment from leaking.

Furthermore, the nozzle (11) has protrusions (12) around the same to be locked onto the subsea equipment interface, after rotating the outer part (13) of the adapter (1). In other words, after connecting (coupling) the nozzle (11) of the adapter (1) to the subsea equipment interface, the adapter (1) is pressed and rotated until the protrusions (12) of the nozzle (11) are aligned below protrusions (not shown) on the inner part of the interface, thus securing and locking the adapter (1) onto the subsea equipment interface.

The inner part (14) of the adapter (1) further has a channel (141) that extends longitudinally along the adapter (1) and allows a fluid communication between the adapter (1) and the subsea equipment interface.

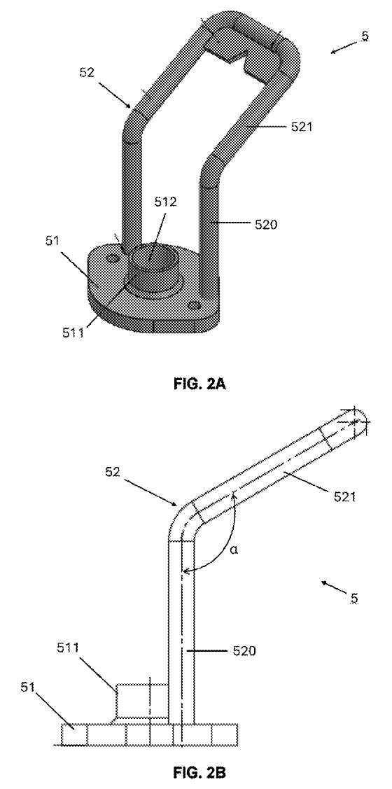

Moreover, according to one embodiment of the present invention, the adapter (1) has an upper base (16) on the outer part (13) for connection with a base (51) of a lower handle (5) of the fluid injection system. In particular, the base (51) of the lower handle (5) is fastened onto the upper base (16) by means of fastening elements (such as nuts and bolts, for example). As can be seen more clearly in FIGS. 2A and 2B, the lower handle (5) further has a rod (52) having a vertical portion (520) and an inclined portion (521), wherein the inclined portion (521) curves outwards, so as to distance itself from the fluid injection system. In embodiments of the present invention, the inclined portion (521) forms an angle α with the vertical portion (520), which may be an acute angle, an obtuse angle, or a right angle. Preferably, the angle α is around 120 degrees. This inclination of the lower handle (5), moving away from the system, facilitates handling by an ROV, by preventing the inadvertent contact between the ROV handler and any component of the system.

Additionally, the base (51) of the lower handle (5) has a protuberance (511) that extends upwards and a hole (512), wherein the protuberance (511) encases a portion of the outer part (13) of the adapter (1) through the hole (512), preventing the lower handle (5) from moving laterally in relation to the adapter (1).

In embodiments of the present invention, the inner part (14) of the adapter (1) has threads at its upper end for connection with a receptacle (2) of the fluid injection system. It is worth emphasizing that the internally threaded interface of the adapter (1) allows it to connect to any desired subsea equipment, depending on the intended operation, not being limited to the connection only with a receptacle (2). Thus, according to one embodiment of the present invention, the receptacle (2) is connected to the upper end of the adapter (1) by means of a lower portion (25) with external threads of the receptacle (2), so that a fluid communication is established between the receptacle (2) and the adapter (1). More specifically, the receptacle (2) has an inner channel (20) that is connected to the channel (141) of the inner part (14) of the adapter (1) to establish the fluid communication between the same.

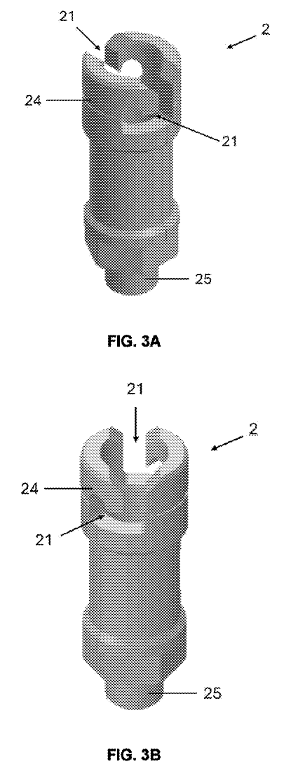

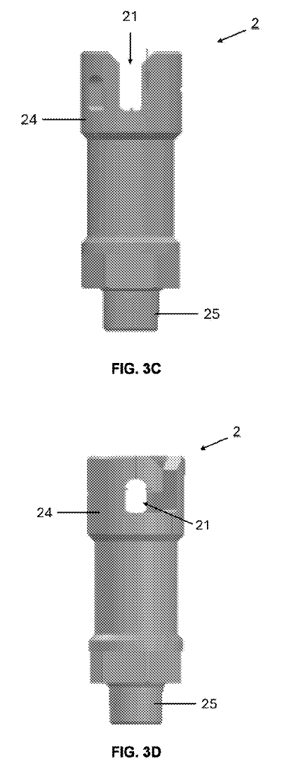

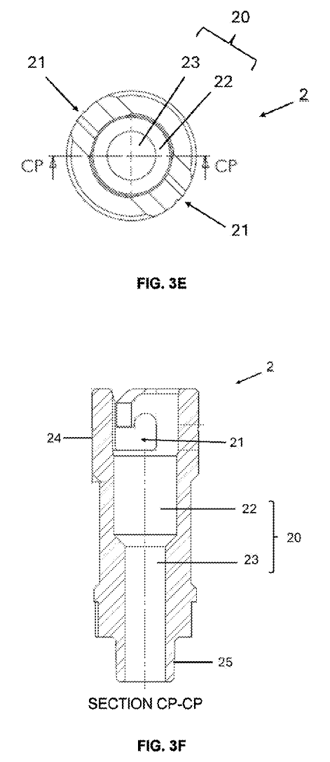

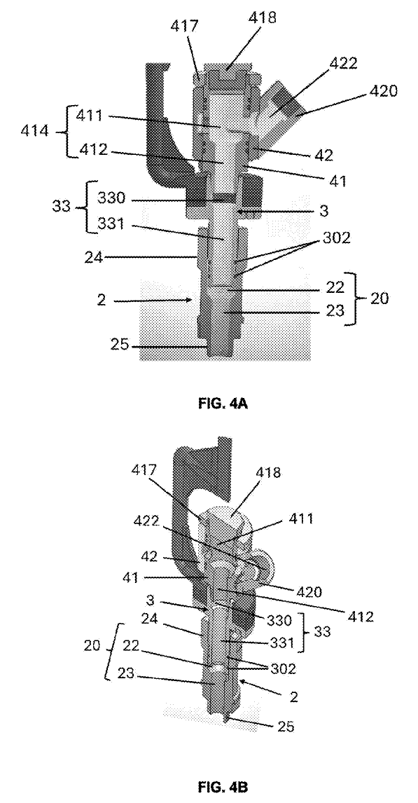

Furthermore, the receptacle (2) includes at least two “J” shaped fitting portions (21) located on opposite sides of an upper portion (24) of the receptacle (2), as shown in FIGS. 3A-3D. As can be seen more clearly in FIGS. 3E, 3F, 4A and 4B, the receptacle (2) further comprises an upper hollow portion (22) and a lower hollow portion (23), which form the inner channel (20), the inner diameter of the upper hollow portion (22) being greater than the inner diameter of the lower hollow portion (23), the upper hollow portion (22) being tapered in the region in which it is connected to the lower hollow portion (23).

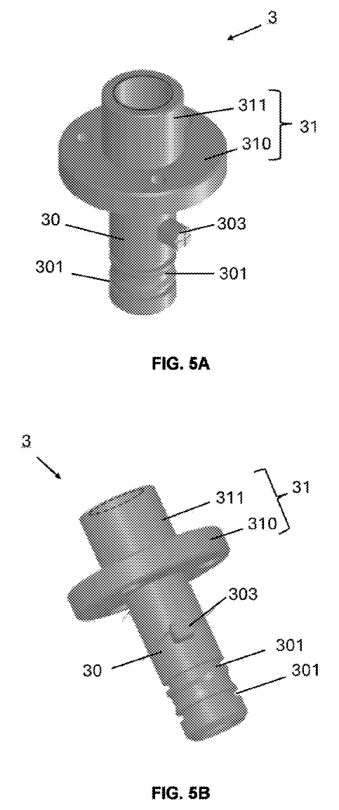

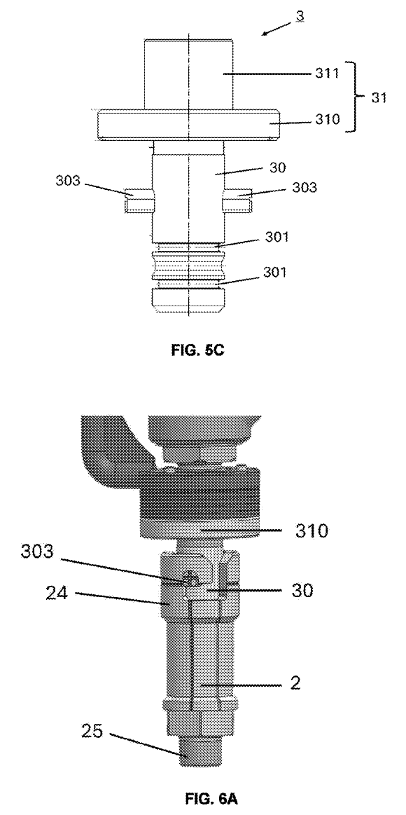

The system of the present invention further comprises a hot stab (3), as shown in FIGS. 1A, 1B, 4A, 4B, 5A, 5B and 5C. The hot stab (3) is connected to an upper end of the receptacle (2), so that the hot stab (3) is in fluid communication with the receptacle (2).

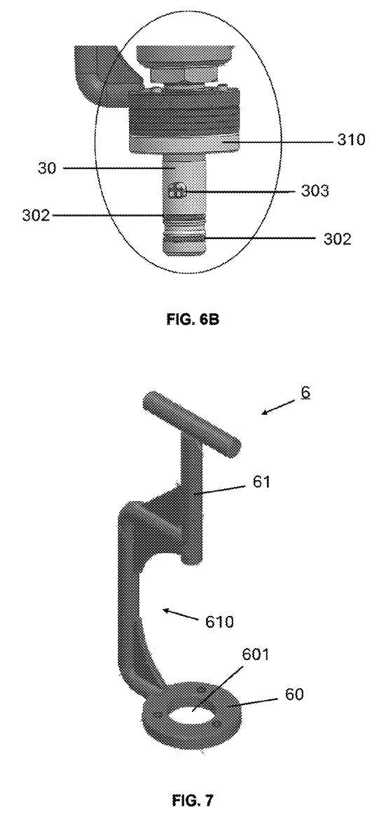

Specifically, the hot stab (3) has an elongated portion (30), which includes at least two recesses (301) for insertion of sealing rings (302) therein and at least two pins (303), one pin (303) being diametrically opposite to the other. In addition, the hot stab (3) has an upper portion (31) comprising a circular portion (310) and a top portion (311). Thus, the elongated portion (30) of the hot stab (3) is inserted into the upper hollow portion (22) of the receptacle (2), so that the pins (303) of the hot stab (3) are each firmly fitted into a corresponding “J” shaped fitting portion of the at least two “J” shaped fitting portions (21) of the receptacle (2). FIGS. 6A and 6B show in greater detail, respectively, the configuration of the connection between the hot stab (3) and the receptacle (2) with the locking of the pins (303) in the “J” shaped fitting portions (21) and the hot stab (3) detached from the receptacle (2). It should be emphasized that the force that keeps the connection stable is that of the fluid pressure itself that is passing through the inside of the hot stab (3). With this pressure, the pins (303) of the hot stab (3) are pushed to the upper inner part of the receptacle (2), maintaining the stability of the connection.

Moreover, the sealing rings (302) inserted in the recesses (301) of the elongated portion (30) prevent the fluid from escaping out of the connection region located between the outer part of the elongated portion (30) of the hot stab (3) and the upper hollow portion (22) of the receptacle (2).

It is further noted that the hot stab (3) has an inner channel (33) formed by an upper hollow portion (330) of the inner part of the top portion (311) and a lower hollow portion (331) of the inner part of the elongated portion (30). This inner channel (33) of the hot stab (3) is connected to the inner channel (20) of the receptacle (2) to establish the fluid communication between the same, as best seen in FIGS. 4A and 4B.

In embodiments of the present invention, the system further comprises an upper handle (6) including a base (60) having a central hole (601) and a gripping portion (61) having an arched region (610), wherein the base (60) is connected over the circular portion (310) of the hot stab (3) by means of fastening elements such as screws. The grip portion (61) assists an ROV in handling the underwater system. FIG. 7 presents the upper handle (6), as previously described.

The system of the present invention further comprises a swivel (4), as can be seen in FIGS. 1A, 4A, 4B, 8A, 8B, 9A and 9B. The swivel (4) is connected to an upper end of the hot stab (3), wherein the swivel (4) is in fluid communication with the hot stab (3). In particular, the swivel (4) comprises a fixed part (41), also called the inner part, and a movable part (42), also called the outer part. The movable part (42) encases, at least partially, the fixed part (41) and is configured to rotate freely around a longitudinal geometric axis of the swivel (4), while the fixed part (41) remains fixedly connected to the hot stab (3).

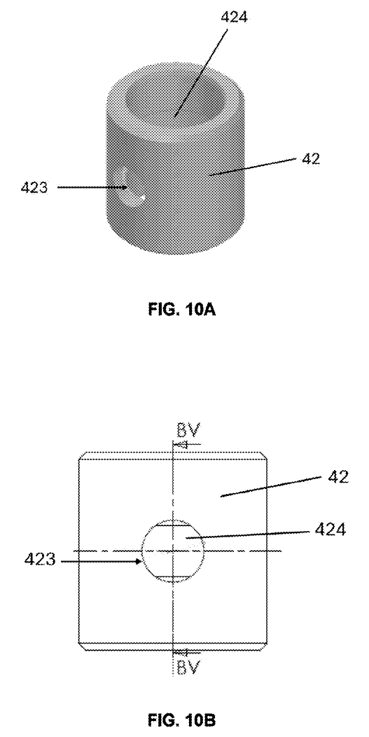

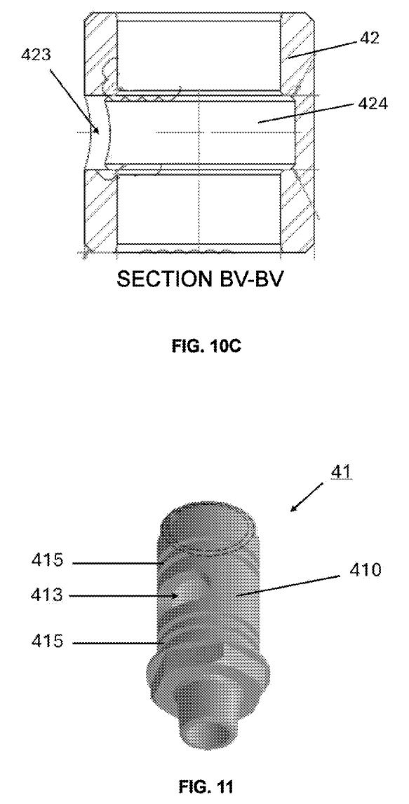

The upper hollow portion (330) of the hot stab (3) has internal threads so that a lower end (410) of the fixed part (41) of the swivel (4), having external threads, is connected therein. Moreover, the movable part (42) has an inlet (420) and a nozzle (421) for connecting a hose or jumper therein. The inlet (420) is connected to the movable part (42), and establishes a fluid communication with the same by means of an inner channel (422) of the inlet (420), which communicates with an orifice (423) of the movable part (42). In addition, when the fluid from the hose or jumper enters through the orifice (423), it travels a path through a groove (424) inside the movable part (42), as can be seen in FIGS. 10A-10C, which defines the fluid communication between these elements.

Furthermore, the fixed part (41) of the swivel (4) has an upper portion (410) having an upper hollow portion (411), a lower hollow portion (412), and lateral slots (413). The lateral slots (413) allow the fluid from the inner channel (422) of the inlet (420) and the groove (424) inside the movable part (42) to enter the upper hollow portion (411) and follow through the lower hollow portion (412) towards the inner channel (33) of the hot stab (3). It should be noted that the upper hollow portion (411) and the lower hollow portion (412) of the fixed part (41) form an inner channel (414) for fluid flow. Thus, the fluid is transported through the inner channels (422, 414, 33, 20, 141) towards the subsea equipment interface.

Moreover, as better seen in FIG. 11, the fixed part (41) further includes at least two recesses (415) for inserting sealing rings (416) therein. The sealing rings (416) inserted in the recesses (415) of the fixed part (41) prevent the fluid from escaping out of the connection region located between the fixed part (41) and the moving part (42).

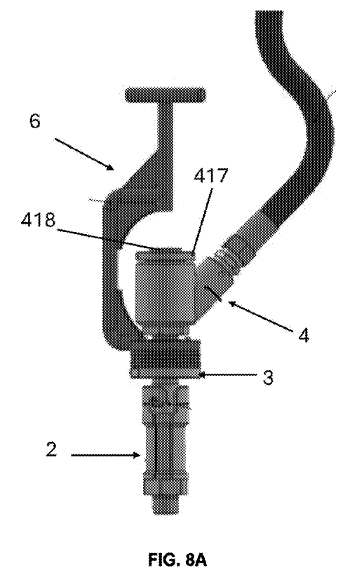

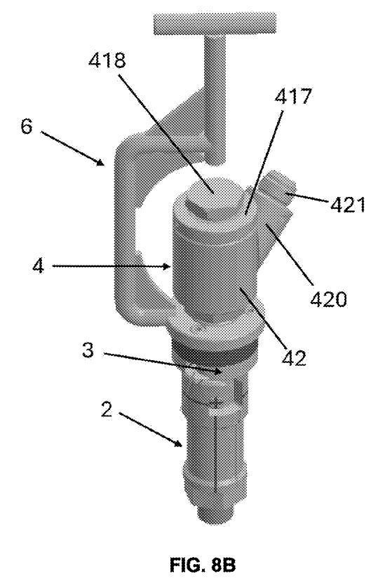

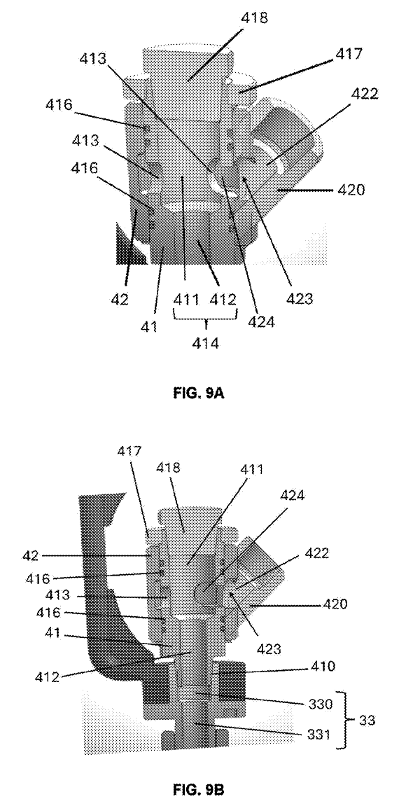

Additionally, as seen in FIGS. 8A, 8B, 9A and 9B, the system further comprises a stop (417) fixedly connected near the upper end of the fixed part (41) of the swivel (4) to prevent the movable part (42) from coming out. Further, a plug (418) is inserted on top of the fixed part (41) to prevent the fluid from escaping therein.

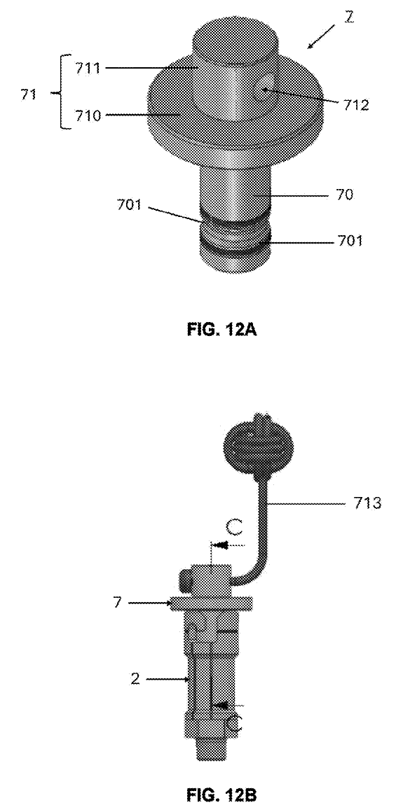

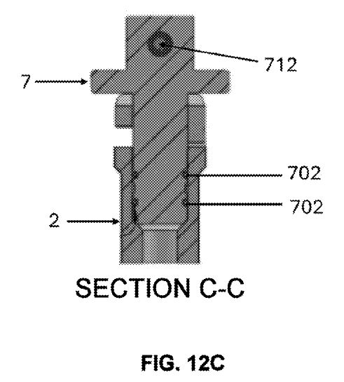

Furthermore, according to one embodiment of the present invention, the system comprises a blind hot stab (7) (also called a plug hot stab), as shown in FIGS. 12A-12C. The blind hot stab (7) is used to plug the receptacle (2), when necessary, for example, in situations in which the upper assembly formed by the hot stab (3), swivel (4) and upper handle (6) has been removed from the receptacle. The blind hot stab (7) has an elongated portion (70), which includes at least two recesses (701) for insertion of sealing rings (702) therein. In addition, the blind hot stab (7) has an upper portion (71) comprising a circular portion (710) and a top portion (711), wherein the top portion (711) comprises a diametral hole (712) for insertion of a monkey fist (713) or any other suitable accessory. Unlike the hot stab (3), the blind hot stab (7) does not have an inner channel for fluid communication with the receptacle (2), since its function is to prevent the entry or exit of fluid.

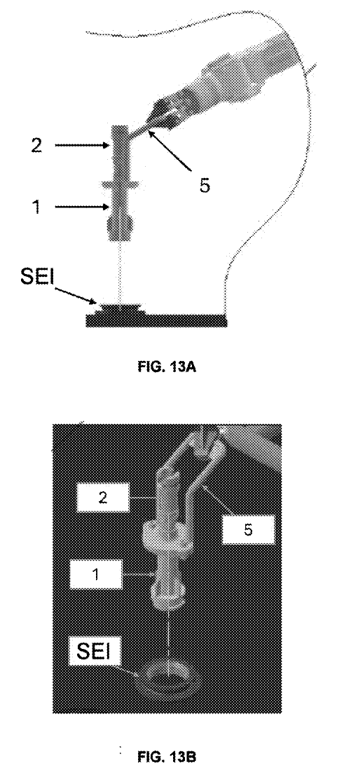

To facilitate the visualization and understanding of how the system components interact with each other, reference is made to FIGS. 13A, 13B, 14A, 14B, 15A, 15B, 16A, 16B, which show how the system is coupled to a subsea equipment interface.

Thus, FIGS. 13A and 13B show an alignment of the lower assembly of the system, consisting of the adapter (1), the receptacle (2) and the lower handle (5), with a subsea equipment interface (SEI) where fluid will be injected. It can be noted that the lower handle (5) is handled by an ROV.

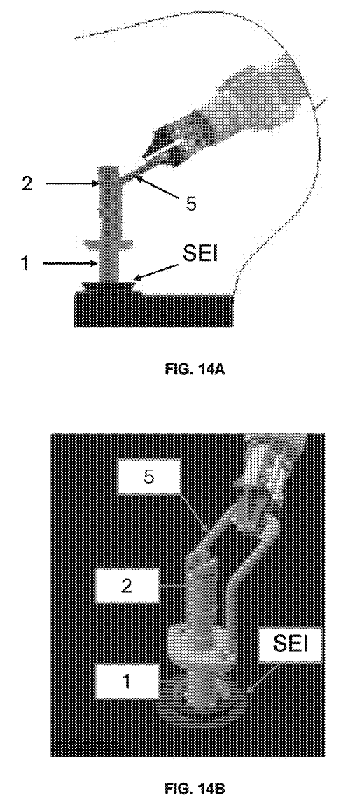

Moreover, after the alignment, the ROV inserts the adapter (1) into the subsea equipment interface (SEI) and rotates to lock the adapter (1) into the subsea equipment interface (SEI), as shown in FIGS. 14A and 14B.

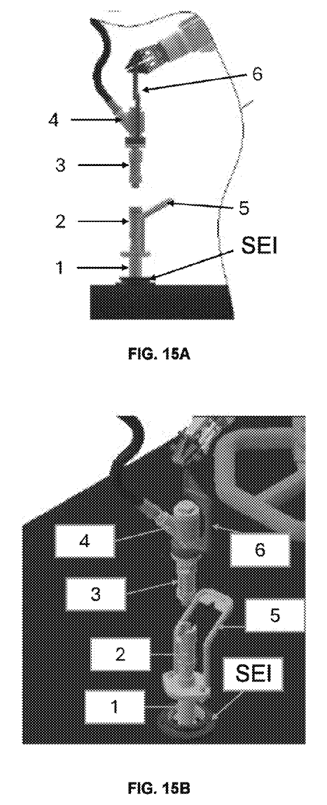

Next, as shown in FIGS. 15A and 15B, an upper assembly consisting of the hot stab (3), the swivel (4) and the upper handle (6) is aligned with the receptacle (2). Note that, in this configuration, the fluid injection jumper is already connected to the inlet (420) of the swivel (4). However, the present invention also provides that the jumper can be connected when the two assemblies, lower and upper, are connected to each other, without departing from the intentions of the invention.

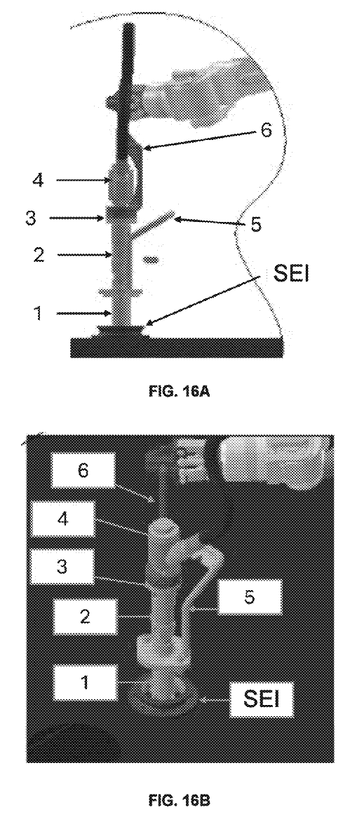

Finally, the hot stab (3) is pressed down by the ROV, by handling the upper handle (6), so that the pins (303) of the hot stab (3) are firmly fitted, each one, into a corresponding “J” shaped fitting portion of the at least two “J” shaped fitting portions (21) of the receptacle (2), locking the upper assembly into the lower assembly, as shown in FIGS. 16A and 16B.

It is important to highlight, based on the various possibilities of assembling the components that form the assemblies of the system of the present invention, the flexibility associated with the system. In addition, the use of a swivel prevents twisting in the jumper, since it allows the jumper to rotate around the longitudinal geometric axis of the swivel.

Thus, the system of the present invention works in harmony and synergy, in an efficient, safe, practical, concise and precise manner. If the components are analyzed separately or in combination with two or more, they could be applied in different tasks, that is, the fluid injection system of the present invention generates several possibilities, in addition to the fluid injection via ROV in a diver interface.

The advantages obtained from the present invention for fluid injection via ROV are diverse and significant. Firstly, replacing the traditional work performed by divers with automated operations with ROVs substantially reduces the risks to the safety of the professionals, minimizing the exposure to hazardous environments. This not only protects the lives of the divers, but also contributes to a safer and more efficient work environment.

In addition, the flexibility provided by the swivel of the system allows the injection hose (or jumper) to be positioned at a plurality of desired angles, increasing the efficiency of operations and facilitating access to difficult areas. This maneuverability improves not only the precision in performing tasks, but also the adaptability of the operation to different underwater scenarios.

Another important point is the versatility of the invention, consisting of a set of components that can be used in various applications and in combination with other tools. This expands the possibilities of use of the invention, allowing it to adapt to different operational needs, not limited only to the fluid injection.

Additionally, the implementation of the invention can result in productivity gains, since the operation via ROV can be carried out continuously and efficiently, without the time and resource limitations associated with the human work in underwater environments. By optimizing the fluid injection process, the invention can also contribute to reducing operating costs.

In summary, the advantages of the invention include: 1. Increased safety for the workers, by minimizing the need for manual interventions in hazardous environments; 2. Greater efficiency and precision in the underwater operations, facilitating the access to challenging areas; 3. Versatility and adaptability, allowing applications in various situations; 4. Potential to increase the productivity and reduce operating costs, optimizing the fluid injection process. These advantages make the invention an innovative and valuable solution for the sector, promoting safer and more efficient underwater operations.

Those skilled in the art will appreciate the knowledge presented herein and may reproduce the invention in the presented embodiments and in other variants, encompassed within the scope of the appended claims.

What is claimed is:

1. A fluid injection system, the system comprising:
an adapter connected by means of a nozzle to a subsea equipment interface for injecting fluids therein, wherein the adapter is in fluid communication with the subsea equipment interface;
a receptacle connected to an upper end of the adapter, wherein the receptacle is in fluid communication with the adapter;
a hot stab connected to an upper end of the receptacle, wherein the hot stab is in fluid communication with the receptacle; and
a swivel connected to an upper end of the hot stab, wherein the swivel is in fluid communication with the hot stab;
wherein the nozzle of the adapter has protrusions around the same, to be locked into the subsea equipment interface, after turning an outer part of the adapter.

2. The system according to claim 1, wherein the adapter has an outer part and an inner part, wherein the nozzle is located at the lower end of the outer part and configured to be connected to the subsea equipment interface.

3. The system according to claim 2, wherein the outer part is free to rotate and the inner part is attached to the subsea equipment interface by means of a polymeric sealing ring disposed between the inner part and the subsea equipment interface.

4. The system according to claim 1, wherein the nozzle has protrusions around the same to be locked onto the interface of subsea equipment.

5. The system according to claim 2, wherein the inner part of the adapter further has a channel that extends longitudinally along the adapter.

6. The system according to claim 1, wherein the adapter has an upper base on the outer part for connection with a base of a lower handle.

7. The system according to claim 6, wherein the lower handle further has a rod having a vertical portion and an inclined portion, wherein the inclined portion curves outwards, so as to distance itself from the fluid injection system.

8. The system according to claim 6, wherein the base of the lower handle has a protuberance that extends upwards, and a hole, wherein the protuberance encases a portion of the outer part of the adapter through the hole, preventing the lower handle from moving laterally in relation to the adapter.

9. The system according to claim 2, wherein the inner part of the adapter has threads at its upper end for connection with a lower portion with external threads of the receptacle.

10. The system according to claim 4, wherein the receptacle has an inner channel that is connected to the channel of the inner part of the adapter to establish the fluid communication between the same.

11. The system according to claim 1, wherein the receptacle includes at least two “J” shaped fitting portions located on opposite sides of each other in an upper portion of the receptacle.

12. The system according to claim 1, wherein the receptacle further comprises an upper hollow portion and a lower hollow portion that form the inner channel, wherein the inner diameter of the upper hollow portion is greater than the inner diameter of the lower hollow portion, the upper hollow portion being tapered in the region where it is connected to the lower hollow portion.

13. The system according claim 1, wherein the hot stab has an elongated portion, which includes at least two recesses for insertion of sealing rings therein, and at least two pins, one pin being diametrically opposite to the other.

14. The system according to claim 1, wherein the hot stab has an upper portion comprising a circular portion and a top portion.

15. The system according to claim 13, wherein the elongated portion of the hot stab is inserted into the upper hollow portion of the receptacle, such that the pins of the hot stab are each firmly fitted into a corresponding “J” shaped fitting portion of the at least two “J” shaped fitting portions of the receptacle.

16. The system according to claim 1, wherein the hot stab has an inner channel formed by an upper hollow portion of the inner part of the top portion, and a lower hollow portion of the inner part of the elongated portion; wherein the inner channel is connected to the inner channel of the receptacle to establish the fluid communication between the same.

17. The system according to claim 1, further comprising an upper handle including a base having a central hole, and a grip portion having an arched region, wherein the base is connected over the circular portion of the hot stab by means of attachment elements.

18. The system according to claim 1, wherein the swivel comprises:
a fixed part, and
a movable part,
wherein the movable part encases, at least partially, the fixed part and is configured to rotate freely around a longitudinal geometric axis of the swivel, while the fixed part remains fixedly connected to the hot stab.

19. The system according to claim 1, wherein an upper hollow portion of the hot stab has internal threads so that a lower end of the fixed part of the swivel, having external threads, is connected therein.

20. The system according to claim 18, wherein the movable part has an inlet and a nozzle for connecting a hose or jumper therein.

21. The system according to claim 20, wherein the inlet is connected to the movable part ( and establishes a fluid communication with the same by means of an inner channel of the inlet that communicates with an orifice of the movable part.

22. The system according to claim 18, wherein the movable part further has a groove inside the same that serves as a fluid path from the orifice.

23. The system according to claim 18, wherein the fixed part of the swivel has an upper portion having:
an upper hollow portion,
a lower hollow portion, and
lateral slots; and
wherein the upper hollow portion and the lower hollow portion of the fixed part form an inner channel for fluid flow.

24. The system according to claim 18, wherein the fixed part further includes at least two recesses for insertion of sealing rings therein.

25. The system according to claim 18, further comprising:
a stop fixedly connected near the upper end of the fixed part of the swivel to prevent the movable part from coming out; and
a plug inserted at the top of the fixed part to prevent fluid from escaping therein.

26. The system according to claim 1, further comprising a blind hot stab used to plug the receptacle.

27. The system according to claim 26, wherein the blind hot stab comprises:
an elongated portion, which includes at least two recesses for insertion of sealing rings therein; and
an upper portion comprising a circular portion and a top portion, wherein the top portion comprises a diametral hole for insertion of a monkey fist.
